(19) United States
(12) Patent Application Publication
(10) Pub. No.: US 2023/0163837 A1
(43) Pub. Date: May 25, 2023

(54) SATELLITE COMMUNICATION EARTH STATION AND COMMUNICATION CONTROL METHOD

(71) Applicant: NIPPON TELEGRAPH AND TELEPHONE CORPORATION, Tokyo (JP)

(72) Inventors: Hiroki SHIBAYAMA, Musashino-shi, Tokyo (JP); Koichi HARADA, Musashino-shi, Tokyo (JP); Masaki SHIMA, Musashino-shi, Tokyo (JP); Fumihiro YAMASHITA, Musashino-shi, Tokyo (JP)

(73) Assignee: NIPPON TELEGRAPH AND TELEPHONE CORPORATION, Tokyo (JP)

(21) Appl. No.: 17/919,585

(22) PCT Filed: Apr. 21, 2020
(86) PCT No.: PCT/JP2020/017242

§ 371 Date: Oct. 18, 2022

(51) Int. Cl. H04B 7/185

(52) U.S. Cl. CPC H04B 7/18517

(57) ABSTRACT

A satellite communication earth station includes a detection unit that detects a longitude, a latitude, an altitude, an azimuth, and an inclination of the antenna, a drive unit that drives the antenna to adjust the azimuth angle, the elevation angle, and the polarization angle of the antenna to the communication satellite, a determination unit that determines whether the longitude, the latitude, the altitude, the azimuth, or the inclination detected by the detection unit or the azimuth angle, the elevation angle, or the polarization angle driven by the drive unit makes a change from an initial setting value to a predetermined threshold value or more, and a minimum control calculation unit that calculates control to minimize a drive amount driven by the drive unit to adjust the current azimuth angle, the elevation angle, and the polarization angle of the antenna to the communication satellite.

### TECHNICAL FIELD

The present disclosure relates to a satellite communication earth station and a communication control method.

### BACKGROUND ART

An existing satellite communication earth station that performs wireless communication with a communication satellite includes a global navigation satellite system (GNSS) receiver, an azimuth sensor, and an acceleration sensor and detects a latitude, a longitude, and an altitude where the satellite communication earth station is located, an azimuth, and an inclination of a ground surface.

The GNSS includes a system that receives radio waves from satellites to measure the position, such as a global positioning system (GPS) and a quasi-zenith satellite system (QZSS).

Also, the satellite communication earth station holds in advance the position (the latitude, the longitude, and the altitude) of the communication satellite in a satellite position storage unit and calculates a direction directed from the satellite communication earth station to the communication satellite (satellite direction) in accordance with the latitude, the longitude, and the altitude of the communication satellite that is a communication counterpart and the latitude, the longitude, and the altitude of the satellite communication earth station, the azimuth, and the inclination of the ground surface when the satellite communication earth station starts communication.

Then, the satellite communication earth station calculates a rotation angle of an azimuth angle control motor of an antenna, a rotation angle of an elevation angle control motor, and a rotation angle of a polarization angle control motor such that the antenna is directed to the satellite and performs setting to direct the antenna to the communication satellite. This allows the satellite communication earth station to communicate with the communication satellite (see PTL 1, for example).

### CITATION LIST

### Patent Literature

PTL 1: JP 5425826 B

### SUMMARY OF THE INVENTION

### Technical Problem

Although the satellite communication earth station adjusts and fixes the direction of the antenna to the communication satellite before communication, the position of the satellite communication earth station may change during communication, or the rotation angle set by each control motor may be changed by force applied to the antenna. At this time, the antenna may be directed to a direction different from the communication satellite, and the satellite communication earth station may give radio wave interference for other satellites.

Unfortunately, in correcting the direction of the antenna such that no radio wave interference is given to other satellites and then resuming communication, the existing antenna needs to be reset from the position and the direction in an initial state, taking time for the setting.

An object of the present disclosure is to provide a satellite communication earth station and a communication control method capable of reducing time taken to reset the direction of an antenna, which has changed due to disturbance, to a predetermined direction.

### Means for Solving the Problem

A satellite communication earth station according to an aspect of the present disclosure for adjusting an azimuth angle, an elevation angle, and a polarization angle of an antenna to a communication satellite and then transmitting and receiving a radio wave between the antenna and the communication satellite includes a detection unit that detects a longitude, a latitude, an altitude, an azimuth, and an inclination of the antenna, a drive unit that drives the antenna to adjust the azimuth angle, the elevation angle, and the polarization angle of the antenna to the communication satellite, a determination unit that determines whether the longitude, the latitude, the altitude, the azimuth, or the inclination detected by the detection unit or the azimuth angle, the elevation angle, or the polarization angle driven by the drive unit makes a change from an initial setting value to a predetermined threshold value or more, a minimum control calculation unit that calculates control to minimize a drive amount driven by the drive unit to adjust the azimuth angle, the elevation angle, and the polarization angle of the antenna at present to the communication satellite when the determination unit determines that the change from the initial setting value to the predetermined threshold value or more is made, and an execution unit that executes the control calculated by the minimum control calculation unit.

Also, a communication control method according to an aspect of the present disclosure for controlling communication of a satellite communication earth station for adjusting an azimuth angle, an elevation angle, and a polarization angle of an antenna to a communication satellite and then transmitting and receiving a radio wave between the antenna and the communication satellite includes detecting a longitude, a latitude, an altitude, an azimuth, and an inclination of the antenna, driving the antenna to adjust the azimuth angle, the elevation angle, and the polarization angle of the antenna to the communication satellite, determining whether the longitude, the latitude, the altitude, the azimuth, or the inclination detected or the azimuth angle, the elevation angle, or the polarization angle driven makes a change from an initial setting value to a predetermined threshold value or more, calculating control to minimize a drive amount driven to adjust the current azimuth angle, the elevation angle, and the polarization angle of the antenna to the communication satellite when it is determined that the change from the initial setting value to the predetermined threshold value or more is made, and executing the calculated control.

### Effects of the Invention

The present disclosure allows for reducing time to set the direction of an antenna, which has changed due to disturbance, to a predetermined direction.

### BRIEF DESCRIPTION OF DRAWINGS

FIG. 1 is a diagram illustrating, as an example, an overview of a satellite communication system according to an embodiment.

FIG. 2 is a functional block diagram illustrating, as an example, an overview of functions that a satellite communication earth station has according to the embodiment.

FIG. 3 is a diagram illustrating, as an example, each value stored in a detection data storage unit.

FIG. 4 is a diagram illustrating, as an example, each value stored in a control value storage unit.

FIG. 5 is a diagram illustrating control calculated by a minimum control calculation unit and stored in a control item storage unit.

FIG. 6 is a flowchart illustrating an operation example of the satellite communication earth station according to the embodiment.

FIG. 7 is a diagram illustrating a hardware configuration example of the satellite communication earth station according to the embodiment.

### DESCRIPTION OF EMBODIMENTS

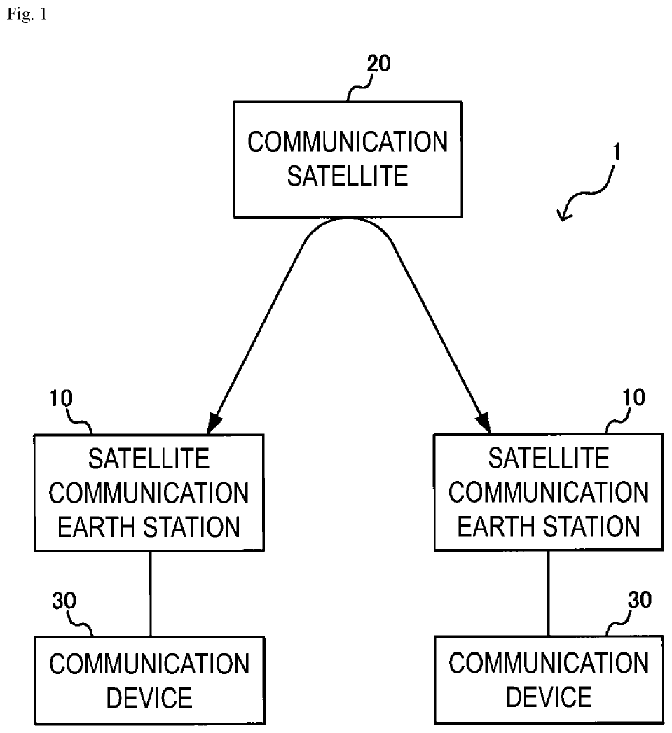

Hereinafter, an embodiment of a satellite communication system will be described using the drawings. FIG. 1 is a diagram illustrating, as an example, an overview of a satellite communication system 1 according to an embodiment. The satellite communication system 1 is, for example, a system in which a plurality of satellite communication earth stations 10 perform wireless communication via a communication satellite 20.

Also, communication devices 30 are connected to each satellite communication earth station 10. In other words, the satellite communication system 1 is a system that enables the plurality of communication devices 30 to perform communication via the satellite communication earth stations 10 and the communication satellite 20. In addition, the satellite communication earth stations 10 adjust azimuth angles, elevation angles, and polarization angles of antennas that the satellite communication earth stations 10 themselves include in accordance with the communication satellite 20 and then transmit and receive radio waves to and from the communication satellite 20.

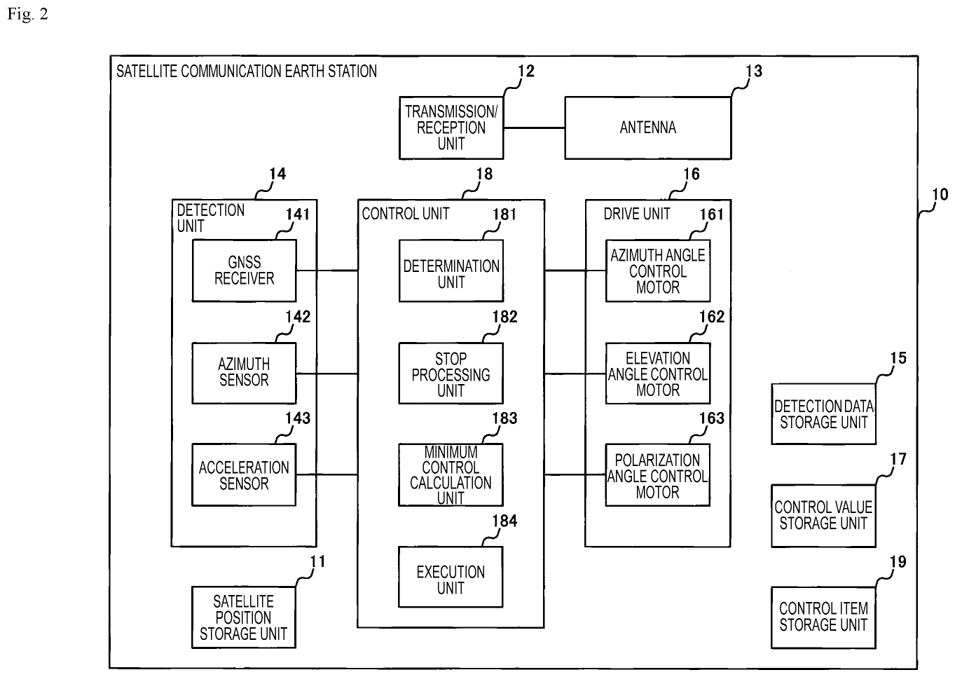

FIG. 2 is a functional block diagram illustrating, as an example, an overview of functions that each satellite communication earth station 10 has according to the embodiment. As illustrated in FIG. 2, the satellite communication earth station 10 includes a satellite position storage unit 11, a transmission/reception unit 12, an antenna 13, a detection unit 14, a detection data storage unit 15, a drive unit 16, a control value storage unit 17, a control unit 18, and a control item storage unit 19.

The satellite position storage unit 11 stores, for example, the position (the latitude, the longitude, and the altitude) of the communication satellite 20 (FIG. 1), which is a stationary satellite, in advance. Note that the communication satellite 20 is not limited to a stationary satellite and may be a moving satellite.

The transmission/reception unit 12 transmits and receives signals to and from the communication satellite 20 via the antenna 13. For example, the transmission/reception unit 12 modulates data transmitted from the satellite communication earth station 10 to the communication satellite 20 into a radio signal and outputs the radio signal to the antenna 13. Also, the transmission/reception unit 12 demodulates the radio signal received by the antenna 13 from the communication satellite 20.

Note that signals transmitted and received by the transmission/reception unit 12 include data (main signal) and control signals used to control line setting and the like among the plurality of satellite communication earth stations 10.

The antenna 13 is provided at an upper portion of the satellite communication earth station 10, for example, such that the azimuth angle, the elevation angle, and the polarization angle thereof become variable, and transmits and receives radio waves to and from the communication satellite 20.

The detection unit 14 includes, for example, a GNSS receiver 141, an azimuth sensor 142, and an acceleration (gravity) sensor 143.

The GNSS receiver 141 detects the latitude, the longitude, and the altitude of the antenna 13 or the satellite communication earth station 10 through reception of signals from navigation satellites, such as a GPS and a QZSS, for example, and outputs the detected latitude, the longitude, and the altitude to the control unit 18. The azimuth sensor 142 detects an azimuth in which the antenna 13 or the satellite communication earth station 10 is directed and outputs the detected azimuth to the control unit 18. The acceleration sensor 143 detects the inclination of the antenna 13 or the satellite communication earth station 10 with respect to an installation surface and outputs the detected inclination to the control unit 18.

Although it is assumed that the detection unit 14 detects each value regarding the antenna 13 here, the detection unit 14 may detect values regarding the satellite communication earth station 10 and regard the values substantially as values for the antenna 13 or may detect values that can be converted into values for the antenna 13.

Also, the detection unit 14 performs the detection at a predetermined cycle when the satellite communication earth station 10 performs communication with the communication satellite 20. Moreover, the detection unit 14 detects the longitude, the latitude, the altitude, the azimuth, and the inclination of the antenna 13 even after elapse of a predetermined time after a stop processing unit 182, which will be described later, causes the transmission of radio waves from the antenna 13 to stop.

The detection data storage unit 15 stores the latitude, the longitude, the altitude, the azimuth, and the inclination detected by the detection unit 14. Note that because the detection unit 14 detects the latitude, the longitude, the altitude, the azimuth, and the inclination at the predetermined cycle when the satellite communication earth station 10 performs communication, the detection data storage unit 15 periodically stores each of the latitude, the longitude, the altitude, the azimuth, and the inclination detected by the detection unit 14. In addition, it is assumed that the detection data storage unit 15 stores a threshold value (which will be described later) of the amount of change for each detection result of the detection unit 14 in advance.

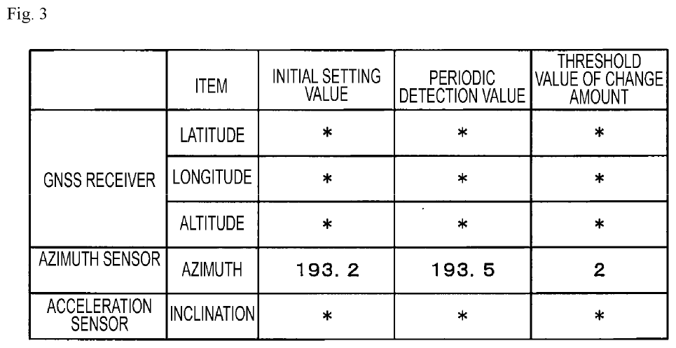

FIG. 3 is a diagram illustrating, as an example, each value stored in the detection data storage unit 15. The detection data storage unit 15 stores an initial setting value, a periodic detection value, and a change amount threshold value for each of the GNSS receiver 141, the azimuth sensor 142, and the acceleration sensor 143, for example.

The drive unit 16 (FIG. 2) includes an azimuth angle control motor 161, an elevation angle control motor 162, and a polarization angle control motor 163.

The azimuth angle control motor 161 drives the antenna 13 such that the azimuth (a rotation angle from the initial setting) in which the antenna 13 is directed is adjusted in accordance with the communication satellite 20 that is a target of communication in accordance with control performed by the control unit 18. The elevation angle control motor 162 drives the antenna 13 such that the elevation angle (a rotation angle from the initial setting) of the antenna 13 is adjusted in accordance with the communication satellite 20 that is a target of communication in accordance with control performed by the control unit 18. The polarization angle control motor 163 drives the antenna 13 such that the polarization angle (a rotation angle from the initial setting) of radio waves transmitted and received by the antenna 13 is adjusted in accordance with the communication satellite 20 that is a target of communication in accordance with control performed by the control unit 18.

For example, the drive unit 16 may perform the driving to adjust the direction of the antenna 13 based on the latitude, the longitude, the altitude, the azimuth, and the inclination detected by the detection unit 14. In other words, the drive unit 16 may drive (adjust) the antenna 13 at a predetermined cycle when the satellite communication earth station 10 performs communication with the communication satellite 20.

The control value storage unit 17 stores each control value (a rotation angle from the initial setting) indicating the amount by which the drive unit 16 has driven the antenna 13.

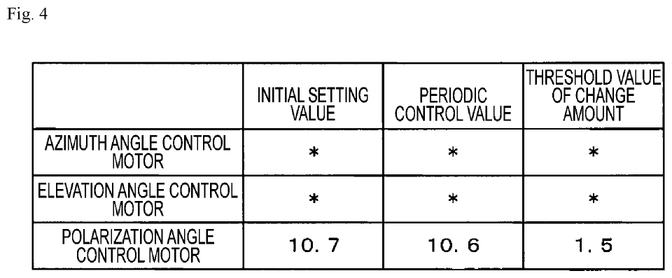

FIG. 4 is a diagram illustrating, as an example, each value stored in the control value storage unit 17. The control value storage unit 17 stores an initial setting value, a periodic detection value, and a change amount threshold value for each of the azimuth angle control motor 161, the elevation angle control motor 162, and the polarization angle control motor 163, for example.

The control unit 18 (FIG. 2) includes, for example, a determination unit 181, a stop processing unit 182, a minimum control calculation unit 183, and an execution unit 184 and controls each component constituting the satellite communication earth station 10. Also, it is assumed that the control unit 18 has a function of calculating a direction directed from the antenna 13 to the communication satellite 20 based on the latitude, the longitude, the altitude, the azimuth, and the inclination of the antenna 13 (or the satellite communication earth station 10).

The determination unit 181 determines whether or not at least any of the longitude, the latitude, the altitude, the azimuth, or the inclination detected by the detection unit 14 or the azimuth angle, the elevation angle, or the polarization angle driven by the drive unit 16 has experienced a change that is equal to or greater than a predetermined threshold value from an initial setting value.

In a case in which the determination unit 181 determines that there has been a change that is equal to or greater than the predetermined threshold value from the initial setting value, the stop processing unit 182 stops the transmission of radio waves (the main signals and the control signals) from the antenna 13 (wave stop processing). Note that the stop processing unit 182 may cause the antenna 13 to stop the transmission of radio waves or may stop the transmission/reception unit 12 to stop the transmission. Moreover, the stop processing unit 182 may lower a transmission level such that no radio wave interferences are provided to other satellites by lowering a transmission power from the antenna 13 by 50 dB, for example, instead of performing the wave stop processing.

In a case in which the determination unit 181 determines that there has been a change that is equal to or greater than the predetermined threshold value from the initial setting value, the minimum control calculation unit 183 calculates control (minimum control) to minimize the drive amount by which the drive unit 16 drives the current azimuth angle, the elevation angle, and the polarization angle of the antenna 13 in accordance with the communication satellite 20 and causes the control item storage unit 19 to store the calculation result.

For example, the minimum control calculation unit 183 performs an arithmetic operation to specify control of reducing the drive amounts of the azimuth angle control motor 161, the elevation angle control motor 162, and the polarization angle control motor 163 such that a time taken to adjust the current azimuth angle, the elevation angle, and the polarization angle of the antenna 13 in accordance with the communication satellite 20 is minimized.

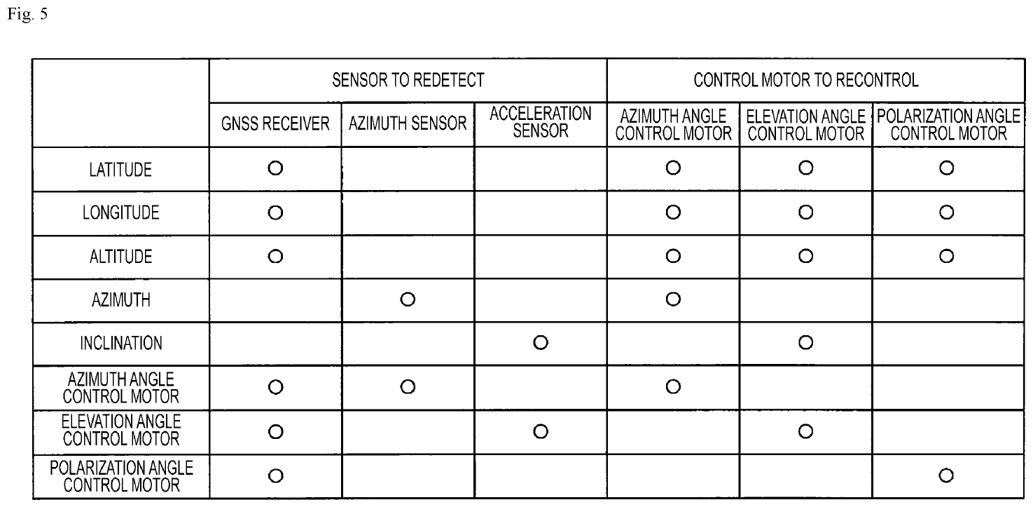

FIG. 5 is a diagram illustrating control (control items) calculated by the minimum control calculation unit 183 and stored in the control item storage unit 19. As illustrated in FIG. 5, in a case in which each of the GNSS receiver 141, the azimuth sensor 142, and the acceleration sensor 143 performs detection again, the minimum control calculation unit 183 calculates only the necessary minimum drive amount to reset the direction of the antenna 13, which has changed due to disturbance, to a predetermined direction.

The control item storage unit 19 also stores a change (an item that requires to be redetected) due to disturbance of the antenna 13. Also, the control item storage unit 19 also stores the control motor to control again. The circle (◯) illustrated in FIG. 5 denotes a correspondence relationship.

In other words, the minimum control calculation unit 183 calculates control for driving only a control motor corresponding to the minimum drive amount from among the azimuth angle control motor 161, the elevation angle control motor 162, and the polarization angle control motor 163.

In a case in which only the polarization angle control motor 163 has deviated from the initial setting value when each of the GNSS receiver 141, the azimuth sensor 142, and the acceleration sensor 143 performs detection again, for example, the minimum control calculation unit 183 calculates control to drive only the polarization angle control motor 163.

In other words, in a case in which only the polarization angle control motor 163 that has deviated from the initial setting value is to be adjusted again, the minimum control calculation unit 183 acquires information regarding the latitude, the longitude, and the altitude again from the GNSS receiver 141 but does not acquire new information from the azimuth sensor 142 and the acceleration sensor 143. Also, the minimum control calculation unit 183 drives only the polarization angle control motor 163 and calculates control of not driving the azimuth angle control motor 161 and the elevation angle control motor 162.

Also, the minimum control calculation unit 183 may perform an arithmetic operation of specifying control to minimize the drive amounts themselves or the numbers of control items of the azimuth angle control motor 161, the elevation angle control motor 162, and the polarization angle control motor 163.

Note that it is assumed that the minimum control calculation unit 183 calculates the control to minimize the drive amount based on the longitude, the latitude, the altitude, the azimuth, and the inclination of the antenna 13 detected by the detection unit 14 after elapse of a predetermined time after the stop processing unit 182 causes the transmission of radio waves from the antenna 13 to be stopped.

The execution unit 184 (FIG. 2) reads the control calculated by the minimum control calculation unit 183 from the control item storage unit 19 and executes the control after elapse of the predetermined time after the stop processing unit 182 causes the transmission of radio waves from the antenna 13 to be stopped.

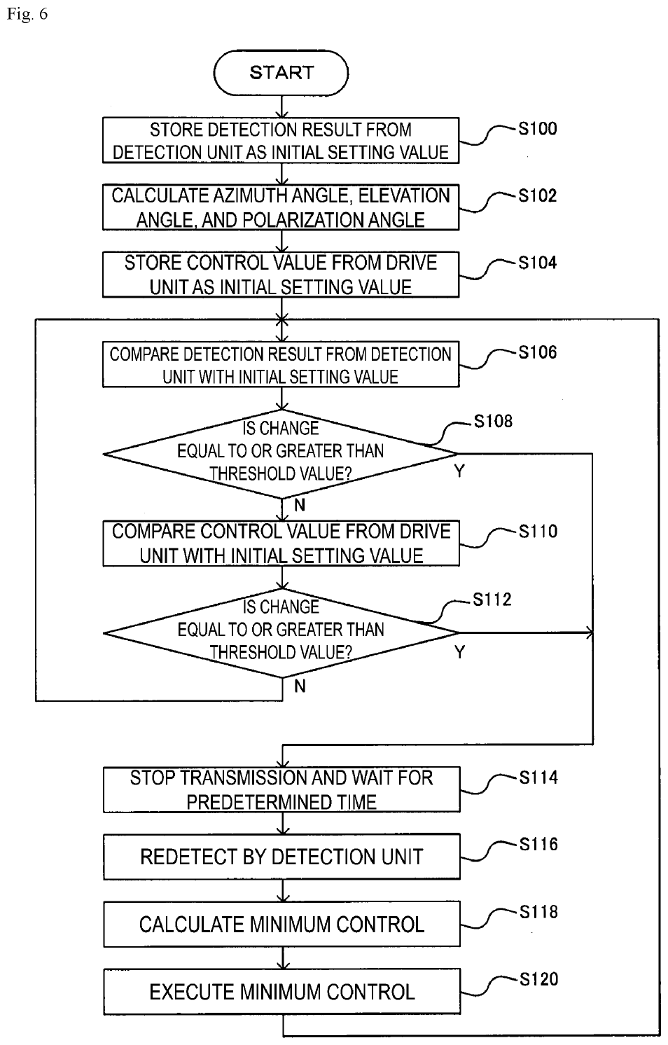

Next, an operation example of the satellite communication earth station 10 will be described. FIG. 6 is a flowchart illustrating an operation example of the satellite communication earth station 10 according to an embodiment.

If the satellite communication earth station 10 starts communication with the communication satellite 20, and the detection unit 14 detects the latitude, the longitude, the altitude, the azimuth, and the inclination of the antenna 13 (or the satellite communication earth station 10), then the detection data storage unit 15 stores each detection result of the detection unit 14 as an initial setting value (S100). For example, as illustrated as an example in FIG. 3, the detection data storage unit 15 stores the value “193.2” degrees as an initial setting value of the azimuth.

Then, the control unit 18 calculates a direction and the like (the azimuth angle, the elevation angle, and the polarization angle) directed from the antenna 13 to the communication satellite 20 based on the latitude, the longitude, the altitude, the azimuth, and the inclination of the antenna 13 (or the satellite communication earth station 10) (S102).

Also, if the drive unit 16 performs driving to direct the antenna 13 to the communication satellite 20, then the control value storage unit 17 stores each control value of the drive unit 16 as an initial setting value (S104).

Next, the determination unit 181 compares the periodic detection result of the detection unit 14 with the initial setting value (S106) and determines whether or not a change in the detection result with respect to the initial setting value is equal to or greater than a threshold value (S108). The determination unit 181 moves on to the processing in S114 in a case in which it is determined that the change is equal to or greater than the threshold value (S108: Yes), or the determination unit 181 moves on to the processing in S110 in a case in which it is determined that the change is not equal to or greater than the threshold value (S108: No).

In a case in which the initial setting value of the azimuth is “193.2” degrees, and the detection data storage unit 15 stores “2” as a change amount threshold value of the azimuth, and if the detection unit 14 detects a value “193.5” degrees as a detection value of the azimuth as illustrated in FIG. 3, for example, the determination unit 181 determines that the change is not equal to or greater than the threshold value.

Also, the determination unit 181 compares the periodic control value (adjustment value) of the drive unit 16 with the initial setting value (S110) and determines whether or not the change of the control value with respect to the initial setting value is equal to or greater than a threshold value (S112). The determination unit 181 moves on to the processing in S114 in a case in which it is determined that the change is equal to or greater than the threshold value (S112: Yes), or the determination unit 181 returns to the processing in S106 in a case in which it is determined that the change is not equal to or greater than the threshold value (S112: No).

In a case in which the initial setting value of the polarization angle is “10.7”, and the control value storage unit 17 stores “1.5” as a change amount threshold value of the polarization angle, and when the control value of the drive unit 16 in regard to the polarization angle is “10.6” as illustrated in FIG. 4, for example, the determination unit 181 determines that the change is not equal to or greater than the threshold value.

In the processing in S114, the stop processing unit 182 causes the transmission of radio waves (the main signals and the control signals) from the antenna 13 to be stopped. At this time, the minimum control calculation unit 183 waits for elapse of a predetermined time after the stop processing unit 182 causes the transmission of radio waves from the antenna 13 to be stopped. Here, the predetermined time is assumed to be a time until the aforementioned change is stabilized.

In the processing in S116, the detection unit 14 redetects the latitude, the longitude, the altitude, the azimuth, and the inclination of the antenna 13 (or the satellite communication earth station 10) after elapse of a predetermined time (detection process after elapse of time). For example, the detection unit 14 redetects the corresponding latitude, the longitude, the altitude, the azimuth, and the inclination based on the change (the item that requires to be redetected) stored in the control item storage unit 19.

In the processing in S118, the minimum control calculation unit 183 calculates control (minimum control) to minimize the drive amount (a drive time, for example) based on the longitude, the latitude, the altitude, the azimuth, and the inclination of the antenna 13 detected by the detection unit 14 after elapse of a predetermined time after the stop processing unit 182 causes the transmission of radio waves from the antenna 13 to be stopped. Note that the minimum control calculation unit 183 causes the control item storage unit 19 to store the calculation result.

In the processing in S120, the control unit 18 executes the minimum control using the execution unit 184 based on the calculation result stored in the control item storage unit 19 and returns to the processing in S106.

In other words, the satellite communication earth station 10 identifies which of the detection results has changed from among the results detected by the GNSS receiver 141, the azimuth sensor 142, and the acceleration sensor 143 or identifies which of control values of control motors has changed. Then, the satellite communication earth station 10 redetects of only the value of the sensor that has changed or control only on the control motor, the control value of which has changed, again to minimize the control for readjustment performed on the antenna 13.

Thus, the satellite communication earth station 10 can shorten the time taken to reset the direction of the antenna 13, which has changed due to disturbance, to a predetermined direction by the minimum control calculation unit 183 calculating the minimum control and the execution unit 184 executing the minimum control.

Note that each function included in the satellite communication earth station 10, the communication satellite 20, and the communication device 30 may be partially or entirely configured with hardware or may be configured as a program to be executed by a processor such as a CPU.

In other words, the satellite communication system 1 according to the present disclosure can be achieved using a computer and the program, and it is possible to record the program in a storage medium or to provide the program through a network.

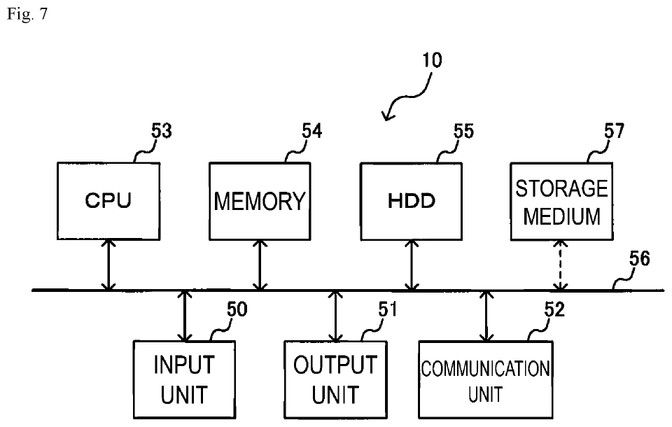

FIG. 7 is a diagram illustrating a hardware configuration example of the satellite communication earth station 10 according to the embodiment. As illustrated in FIG. 7, the satellite communication earth station 10 has functions of a computer with an input unit 50, an output unit 51, a communication unit 52, a CPU 53, a memory 54, and an HDD 55 connected via a bus 56, for example. Also, the satellite communication earth station 10 is adapted to be able to input and output data to and from the storage medium 57.

The input unit 50 is, for example, a keyboard, a mouse, and the like. The output unit 51 is, for example, a display device such as a display. The communication unit 52 is, for example, a wireless network interface.

The CPU 53 controls each component constituting the satellite communication earth station 10 and performs the aforementioned processing. The memory 54 and the HDD 55 store data. The storage medium 57 is adapted to be able to store a received program and the like that causes the functions included in the satellite communication earth station 10 to be executed. Note that the architecture constituting the satellite communication earth station 10 is not limited to the example illustrated in FIG. 7. Also, the communication satellite 20 and the communication device 30 may also include configurations similar to that of the satellite communication earth station 10.

### Reference Signs List

1 Satellite communication system
10 Satellite communication earth station
11 Satellite position storage unit
12 Transmission/reception unit
13 Antenna
14 Detection unit
15 Detection data storage unit
16 Drive unit
17 Control value storage unit
18 Control unit
19 Control item storage unit
20 Communication satellite
30 Communication device
50 Input unit
51 Output unit
52 Communication unit
53 CPU
54 Memory
55 HDD
56 Bus
57 Storage medium
141 GNSS receiver
142 Azimuth sensor
143 Acceleration sensor
161 Azimuth angle control motor
162 Elevation angle control motor
163 Polarization angle control motor
181 Determination unit
182 Stop processing unit
183 Minimum control calculation unit
184 Execution unit

1. A satellite communication earth station for adjusting an azimuth angle, an elevation angle, and a polarization angle of an antenna to a communication satellite and then transmitting and receiving a radio wave between the antenna and the communication satellite, the satellite communication earth station comprising:
a detection unit configured to detect a longitude, a latitude, an altitude, an azimuth, and an inclination of the antenna;
a drive unit configured to drive the antenna to adjust the azimuth angle, the elevation angle, and the polarization angle of the antenna to the communication satellite;
a determination unit configured to determine whether the longitude, the latitude, the altitude, the azimuth, or the inclination detected by the detection unit or the azimuth angle, the elevation angle, or the polarization angle driven by the drive unit makes a change from an initial setting value to a predetermined threshold value or more;
a minimum control calculation unit configured to calculate control to minimize a drive amount driven by the drive unit to adjust the azimuth angle, the elevation angle, and the polarization angle of the antenna at present to the communication satellite when the determination unit determines that the change from the initial setting value to the predetermined threshold value or more is made; and
an execution unit configured to execute the control calculated by the minimum control calculation unit.

2. The satellite communication earth station according to claim 1, further comprising
a stop processing unit configured to stop transmission of the radio wave from the antenna when the determination unit determines that the change from the initial setting value to the predetermined threshold value or more is made, wherein
the execution unit
executes the control calculated by the minimum control calculation unit after elapse of a predetermined time after the stop processing unit stops the transmission of the radio wave from the antenna.

3. The satellite communication earth station according to claim 2, wherein
the detection unit
detects the longitude, the latitude, the altitude, the azimuth, and the inclination of the antenna after elapse of the predetermined time after the stop processing unit stops the transmission of the radio wave from the antenna, and
the minimum control calculation unit
calculates the control to minimize the drive amount in accordance with the longitude, the latitude, the altitude, the azimuth, and the inclination of the antenna detected by the detection unit after elapse of the predetermined time after the stop processing unit stops the transmission of the radio wave from the antenna.

4. A communication control method for controlling communication of a satellite communication earth station for adjusting an azimuth angle, an elevation angle, and a polarization angle of an antenna to a communication satellite and then transmitting and receiving a radio wave between the antenna and the communication satellite, the method comprising:
detecting a longitude, a latitude, an altitude, an azimuth, and an inclination of the antenna;
driving the antenna to adjust the azimuth angle, the elevation angle, and the polarization angle of the antenna to the communication satellite;
determining whether the longitude, the latitude, the altitude, the azimuth, or the inclination detected or the azimuth angle, the elevation angle, or the polarization angle driven makes a change from an initial setting value to a predetermined threshold value or more;
calculating control to minimize a drive amount driven to adjust the azimuth angle, the elevation angle, and the polarization angle of the antenna at present to the communication satellite when it is determined that the change from the initial setting value to the predetermined threshold value or more is made; and
executing the control calculated.

5. The communication control method according to claim 4, further comprising
stopping transmission of the radio wave from the antenna when it is determined that the change from the initial setting value to the predetermined threshold value or more is made, wherein
the executing executes the control calculated after elapse of a predetermined time after the transmission of the radio wave from the antenna is stopped.

6. The communication control method according to claim 5, further comprising
detecting the longitude, the latitude, the altitude, the azimuth, and the inclination of the antenna after elapse of the predetermined time after the transmission of the radio wave from the antenna is stopped, wherein
the calculating calculates the control to minimize the drive amount driven in accordance with the longitude, the latitude, the altitude, the azimuth, and the inclination of the antenna detected after elapse of the predetermined time after the transmission of the radio wave from the antenna is stopped.
